(19) United States
(12) Patent Application Publication
(10) Pub. No.: US 2012/0090942 A1
(43) Pub. Date: Apr. 19, 2012

(54) ATV Drive Train Energy Absorbing Device

(75) Inventors: Mitchell R. Lawson, Vancouver, WA (US); Kyle L. Gilham, Wilsonville, OR (US)

(73) Assignee: WARN INDUSTRIES, INC., Milwaukie, OR (US)

(21) Appl. No.: 12/906,727

(22) Filed: Oct. 18, 2010

(51) Int. Cl. F16D 7/02

(52) U.S. Cl. 192/56.6

(57) ABSTRACT

An energy absorbing device limits peak torque and shock loads applied to the drive train components of an all-terrain vehicle. The energy absorbing device may be installed in the differential or drive housing, inboard of the variable shaft or half-shaft or outboard of the constant shaft or half-shaft, and in the interconnecting shaft itself. The energy absorbing device allows excessive drive train energy to be dissipated by friction between components of the energy absorbing device.

### FIELD

The present disclosure relates to a drive train for an all-terrain vehicle, and more particularly, to a drive train for an all-terrain vehicle using an energy absorbing device to limit peak torque and shock loads applied to the components of the drive train.

### BACKGROUND

This section provides background information related to the present disclosure which is not necessarily prior art.

All-terrain vehicles and utility-terrain vehicles (ATVs & UTVs) are generally of relatively small size and weight and are configured to carry one or two passengers, but may also be configured to seat more than one person side by side or in two or more rows of seats. Such ATVs or UTVs are generally provided with four wheels having all-wheel drive. Vehicle of this type have become increasingly popular and are used for recreation, hunting, and maintenance. Because of the widespread off-road and recreational use of these vehicles, on rough terrain, the components of the drive train are often exposed to large peak loads and shock loads that can lead to failure or damage to the drive train components.

### SUMMARY

This section provides a general summary of the disclosure, and is not a comprehensive disclosure of its full scope or all of its features.

The present disclosure provides an energy absorbing device to limit peak torque and shock loads applied to the drive train components of an all-terrain or utility-terrain vehicle. The device may be installed in the differential or drive housing, inboard of the variable shaft or half-shaft or outboard of the constant shaft or half-shaft, and in the interconnecting shaft itself. The energy absorbing device allows excessive drive train energy to be dissipated by friction between components of the energy absorbing device or storage of energy using some form of torsional, helical, leaf spring, plate clutch, or cone type clutch.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary all-terrain vehicle in accordance with the principles of the present disclosure;

FIG. 2 is a schematic diagram of a power train for an all-terrain vehicle incorporating an energy absorbing device according to the principles of the present disclosure;

FIG. 3 is a cross-sectional view of an energy absorbing device for use in the drive train of an all-terrain vehicle, according to the principles of the present disclosure;

FIG. 4 is a perspective view of an energy absorbing device utilized in the drive train of an all-terrain vehicle, according to the principles of the present disclosure;

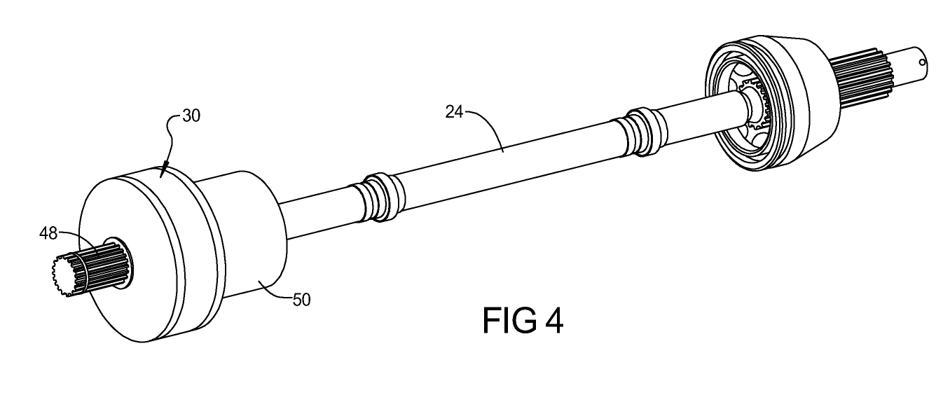

FIG. 5 is a cross-sectional view of an alternative energy absorbing device, according to a second embodiment of the present disclosure;

FIG. 6 is a schematic diagram showing various locations for implementing an energy absorbing device in a drive train of an all-terrain vehicle, according to the principles of the present disclosure; and

FIG. 7 is a cross-sectional view of an energy absorbing device utilizing a ball detent mechanism, according to a third embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

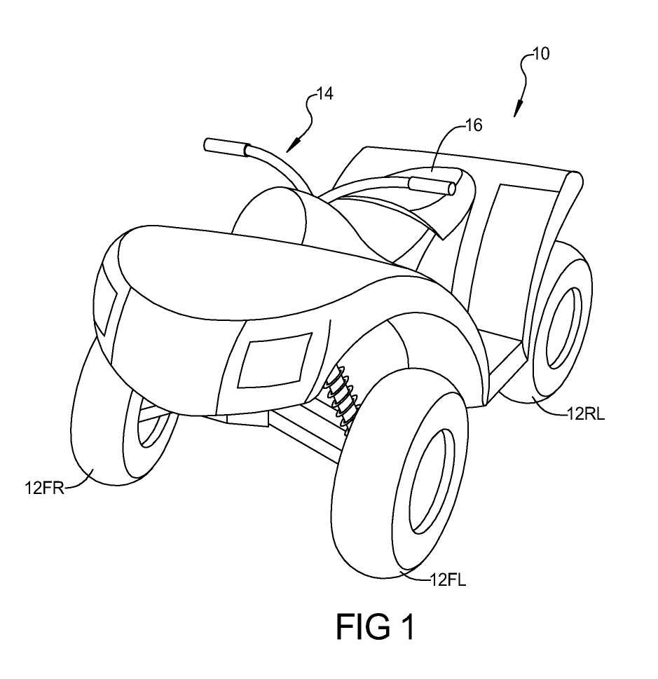

With reference to FIG. 1, an exemplary all-terrain vehicle or utility-terrain vehicle (ATV or UTV) 10 is shown. The all-terrain or utility-terrain vehicle 10 as shown, includes four wheels 12, although it should be understood that more or fewer wheels can be provided. The all-terrain vehicle 10 can include a handlebar 14, or alternatively, can be provided with a steering wheel, as is known in the art. A saddle-type seat 16 can be provided that allows seating for one or two riders, while alternatively, a bench-type seat can be utilized. A suspension system (not shown) is provided for connecting a frame of the all-terrain vehicle to the wheels 12FL, 12FR, 12RL, 12RR.

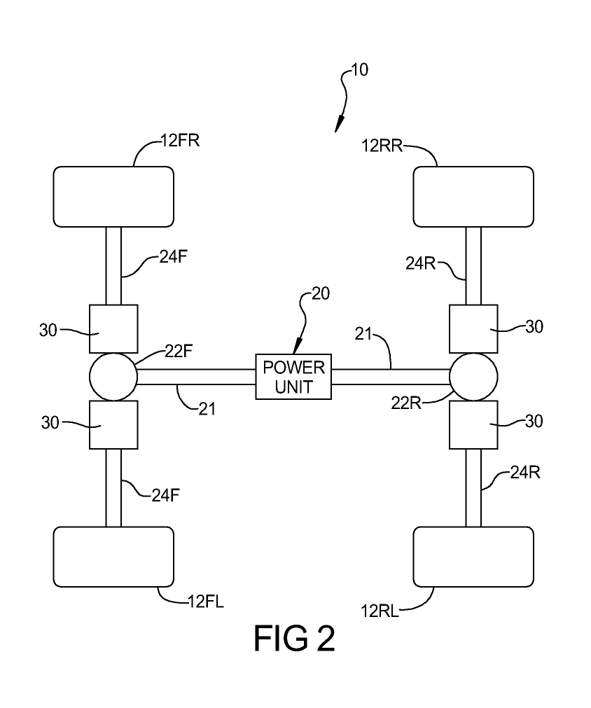

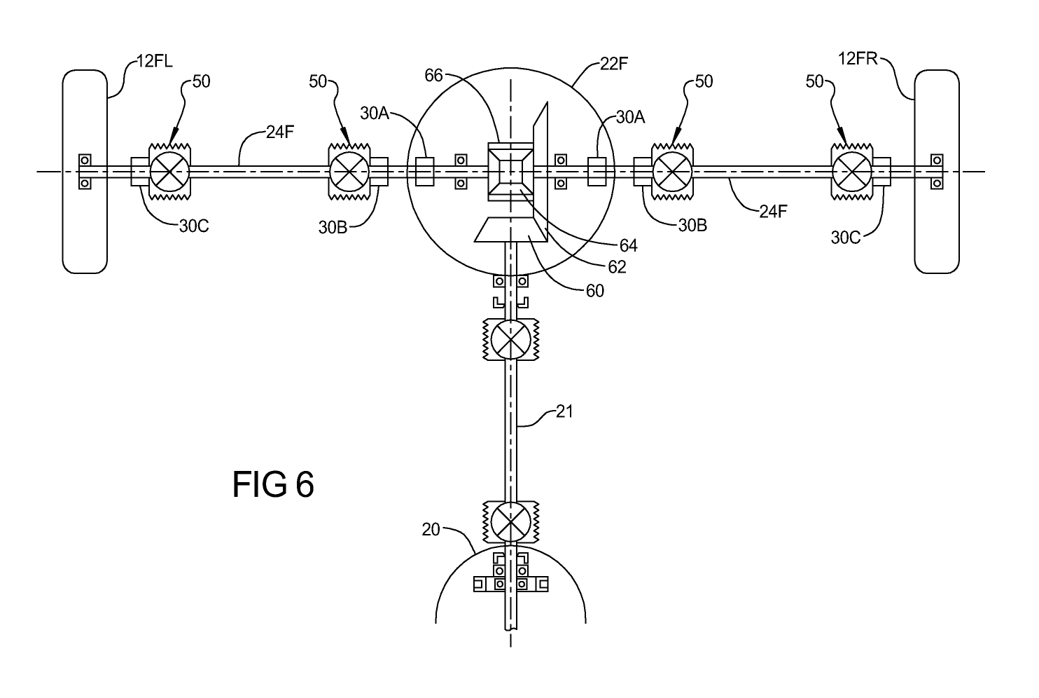

With reference to FIGS. 2 and 6, the vehicle power train will now be described. The vehicle power train includes a power unit 20 that preferably includes an engine and a transmission. The transmission can be either of the gear type, or alternatively, can be a belt drive continuously variable transmission or any other known type of transmission that is commonly utilized in the art. The power unit 20 provides output through a prop shaft 21 (FIG. 2 or 6) to one or more differential units 22F, 22R that distribute the torque input to drive axle pairs 24F, 24R. The differential units can include a hypoid pinion gear 60 driven by the prop shaft 21, and drivingly engaged with a hypoid ring gear 62. The drive axle pairs 24F, 24R are drivingly connected to each of the drive wheels 12FL, 12FR, 12RL, 12RR. An energy absorbing device 30 is provided in the drive line between one or more of the wheels and the differentials 22F, 22R. The energy absorbing device 30 limits the peak torque and shock loads that are applied to the drive train components. The energy absorbing device 30 may be installed in the differential housing, inboard of the half-shaft, or outboard of the half-shaft, or in the interconnecting shaft itself, as will be described in greater detail herein. Differential gears 64 and a differential carrier 66, as are known in the art, provide an output to the half shafts 24.

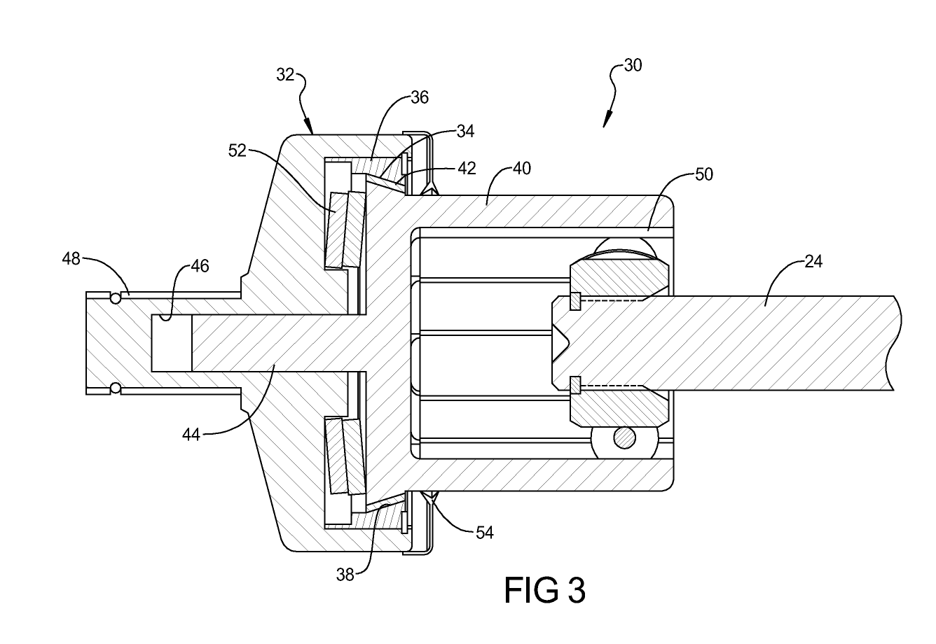

With reference to FIG. 3, the energy absorbing device 30 will now be described in greater detail. The energy absorbing device 30 includes a clutch housing 32 that houses a cone clutch 34 therein. The cone clutch 34 includes a stator 36 that defines a conical interior friction surface 38, a clutch output member 40 is provided and includes a conical exterior friction surface 42 that engages the friction surface 38 of the stator 36. The clutch output member 40 can include a pilot 44 that is rotatably received within a bore 46 of the clutch housing 32. The clutch housing 32 can include a drive shaft portion 48 for connecting to the differential. Alternatively, the clutch housing 32 can be connected to a half-shaft. The clutch output member 40 can define a plunge joint connection 50 with a half-shaft 24. The plunge joint connection 50 allows for a continual drive connection to the axle shaft while the drive wheels are connected to the suspension system and can move up and down while traversing rough terrain. The plunge joint allows the shaft 24 to move angularly and axially relative to the output member 40, while maintaining a rotary connection. Plunge joints 50 of the type shown are well known in the art and therefore, will not be described in greater detail herein. The joint may also be of the Cardan type.

A preload spring device 52 is provided within the clutch housing 32 and biases the clutch output member 40 in an axial direction to provide friction engagement between the conical friction surfaces 42 and 38. The spring device 52 can be in the form of belleville springs or can take on other known forms. A seal 54 can be provided for preventing dirt, debris, and water from entering the energy absorbing device 30.

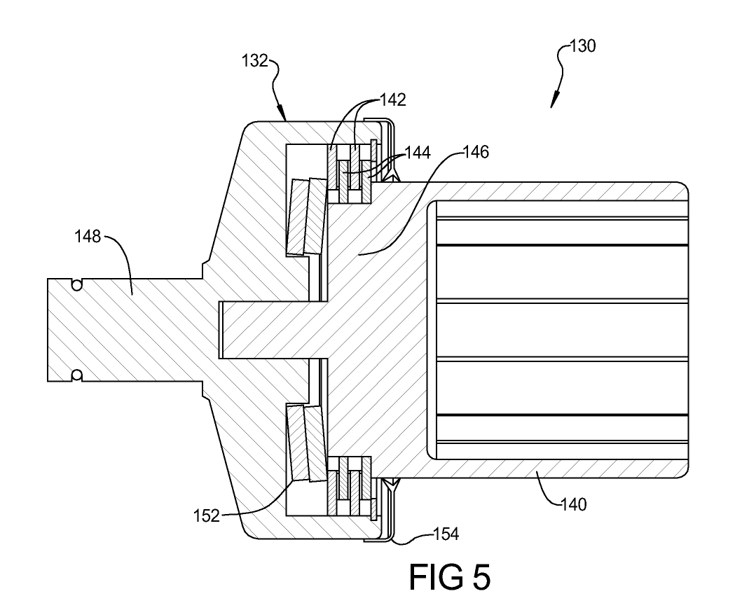

As shown in FIG. 5, an alternative energy absorbing device 130 is shown in which the conical surfaces have been replaced with a series of flat disks that are alternatively connected to the clutch housing 132 and to the clutch output member 140. In particular, a first series of disks 142 include external splines which are connected to internal splines of the clutch housing 132. A second series of disks 144 are interleaved with the disks 142 and include internal splines which are connected to external splines on a hub portion 146 of the clutch output member 140. The clutch output member 140 again provides a plunge joint connection 50 to an axle shaft or other component of the drive train. Furthermore, the clutch housing 132 can be provided with a shaft portion 148 that can be connected to the differential or to another drive train component. A seal 154 can be provided for preventing contaminants from entering the energy absorbing device 130. A spring 152 is provided for providing a biasing force against the friction disks 142, 144.

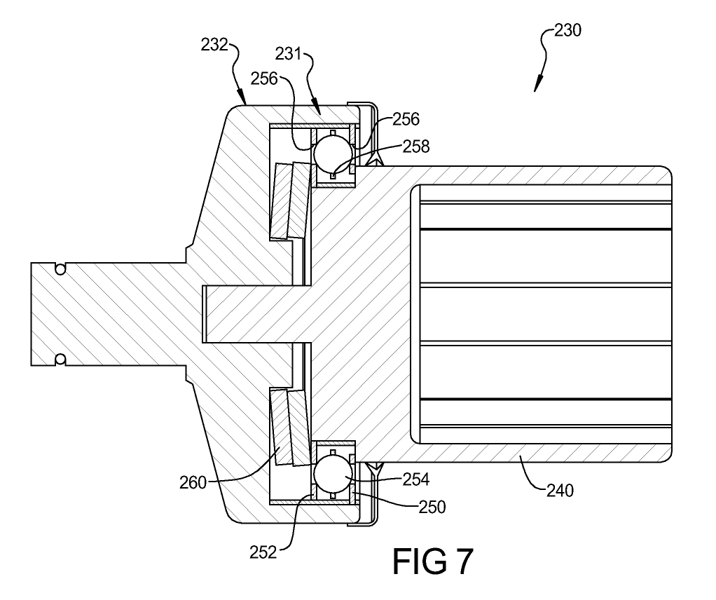

With reference to FIG. 7, an alternative energy absorbing device 230 is shown including a ball detent type mechanism 231 for providing the energy absorbing function. In particular, the ball detent mechanism 230 can include a first detent plate 250 connected to the clutch housing 232 and a second detent plate 252 connected to the clutch output member 240. A series of balls 254 are received in recessed openings or bores 256 provided in the detent plates 250, 252. A cage 258 can be provided for supporting the balls 254 in between the detent plates 250, 252. A preload spring 260 is provided for biasing the second detent plate 252 toward the first detent plate 250 so that the balls 254 tend to seat within the recessed openings or bores 256 in each of the detent plates 250, 252. When the energy absorbing device 230 is exposed to excessive drive torque, the detent plate 252 presses against the spring 260 while the balls 254 roll along the surfaces of the detent plates 250, 252, allowing the clutch output member 240 to rotate relative to the clutch housing 232, and vice versa, until the excessive torque load is reduced and the balls are again received in the bores or openings 256 in each of the detent plates 250, 252.

With reference to FIG. 6, the various possible locations for locating the energy absorbing device according to the principles of the present disclosure are shown. In particular, as shown in FIG. 6, the energy absorbing device 30 can be implemented in the differential housing as illustrated by 30A, can be provided inboard of the interconnecting shaft 24 as illustrated by 30B, can be provided outboard of the interconnecting shaft 24 as illustrated by 30C.

The energy absorbing device of the present disclosure allows excessive drive train energy in an all-terrain vehicle to be dissipated by friction between components of the drive train. Alternatively, storage of energy using some form of torsional, helical, or leaf spring can alternatively be utilized.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A drive train for an all terrain vehicle, comprising:
an engine;
a transmission mechanism drivingly connected to said engine;
a differential drivingly connected to said transmission mechanism and drivingly connected to a wheel of the vehicle;
an energy absorbing device disposed between said differential and said wheel, said energy absorbing device including a clutch housing adapted to be drivingly connected to one of an output of said differential and said wheel, a clutch shaft received in said clutch housing, said clutch housing and said clutch shaft each including friction surfaces that are spring biased toward one another for limiting relative rotational movement between said clutch housing and said clutch shaft and limiting peak torque and shock loads applied to drivetrain components.

2. The drive train according to claim 1, wherein said friction surfaces of said clutch housing and said clutch shaft are conical.

3. The drive train according to claim 1, wherein said friction surfaces of said clutch housing and said clutch shaft include clutch disks connected to said clutch housing and said clutch shaft.

4. The drive train according to claim 1, wherein said energy absorbing device is disposed at an inboard end of an axle shaft.

5. The drive train according to claim 1, wherein said energy absorbing device is disposed at an outboard end of an axle shaft.

6. The drive train according to claim 1, wherein said energy absorbing device is disposed inside a differential housing.

7. A drive train for an all terrain vehicle, comprising:
an engine;
a transmission mechanism drivingly connected to said engine;
a differential drivingly connected to said transmission mechanism and drivingly connected to a wheel of the vehicle;
an energy absorbing device disposed between said differential and said wheel, said energy absorbing device including a clutch housing adapted to be drivingly connected to one of an output of said differential and said wheel, a clutch shaft received in said clutch housing, a spring loaded ball detent mechanism disposed between said clutch housing and said clutch shaft for limiting relative rotational movement between said clutch housing and said clutch shaft and limiting peak torque and shock loads applied to drivetrain components.

8. The drive train according to claim 7, wherein said energy absorbing device is disposed at an inboard end of an axle shaft.

9. The drive train according to claim 7, wherein said energy absorbing device is disposed at an outboard end of an axle shaft.

10. The drive train according to claim 7, wherein said energy absorbing device is disposed inside a differential housing.
